(19) United States
(12) Patent Application Publication
(10) Pub. No.: US 2007/0220285 A1
(43) Pub. Date: Sep. 20, 2007

(54) Power supply apparatus of computer system

(75) Inventor: Sen Jan, Taoyuan City (TW)

Correspondence Address: TROXELL LAW OFFICE PLLC, SUITE 1404, 5205 LEESBURG PIKE, FALLS CHURCH, VA, 22041, US

(73) Assignee: SPI Electronic Co., Ltd.

(21) Appl. No.: 11/378,641

(22) Filed: Mar. 20, 2006

(51) Int. Cl. G06F 1/26

(52) U.S. Cl. 713/300

(57) ABSTRACT

The present invention discloses a computer system that includes a primary power supply and at least one auxiliary power supply, and the auxiliary power supply is built in the casing of the computer system or externally connected to the display chip module of the computer system, such that the auxiliary power supply supplies the electric power required for the operations of the display chip module, so as to assure the stability of the operations of the computer system, and improving the performance of the computer system.

### BACKGROUND OF THE INVENTION

1. Field of the Invention

The present invention relates to a power supply apparatus of a computer system, and more particularly to an auxiliary power supply that supplies the electric power required for the operations of a display chip module, so as to assure a stability of the operations of the computer system and improve the performance of the computer system.

2. Description of the Related Art

Referring to FIGS. 1 and 2 for the basic architecture of a general computer system, the computer system comprises a casing 11 as its body, and the casing 11 installs major built-in components such as a motherboard 12, a microprocessor 13, a hard disk drive 14, an optical disk drive 15, and a display chip module 16 and includes a power supply 17 for converting public utility AC (alternating current) electric power into DC (direct current) electric power required for the operations of the computer system. Therefore, the power supply 17 is the power source for the computer system apparatus that determines the stability of the operations and the long-use quality of the computer system.

Since the power source of the computer system apparatus comes from a DC power converted by the power supply, the basic architecture of a computer system can use a single 300W (watt) power supply to meet the power consumption requirement of the basic components installed on the motherboard. However, the operating speeds of the microprocessor and the display chip module are increased, and thus the overall power consumption of the computer system will increase greatly, particularly for an upgrade to an enhanced display chip module. Therefore, the general single power supply sold in the market may not be able to maintain a normal operation of the overall computer system apparatus, or may even damage the related equipments due to the unstable currents.

### SUMMARY OF THE INVENTION

In view of the shortcomings of the prior art, the inventor of the invention based on years of experience in the related industry to conduct extensive researches and experiments, and finally invented a computer system apparatus in accordance with the invention.

Therefore, it is a primary objective of the present invention to use an auxiliary power supply to supply the electric power required for the operation of a display chip module to assure the stability of the operations and improve the performance of the of the computer system.

In an embodiment of the invention, the computer system installs a primary power supply and at least one auxiliary power supply, and the auxiliary power supply is built in the casing or externally connected to couple with the circuit of the computer system, so as to assist the power supply to share supplying electric power required by the display chip module, stabilize the operations of the computer system, and improve the operating performance.

### BRIEF DESCRIPTION OF THE DRAWINGS

The present invention will now be described in more detail hereinafter with reference to the accompanying drawings that show various embodiments of the invention, in which:

FIG. 1 is a perspective view of a prior art computer system apparatus;

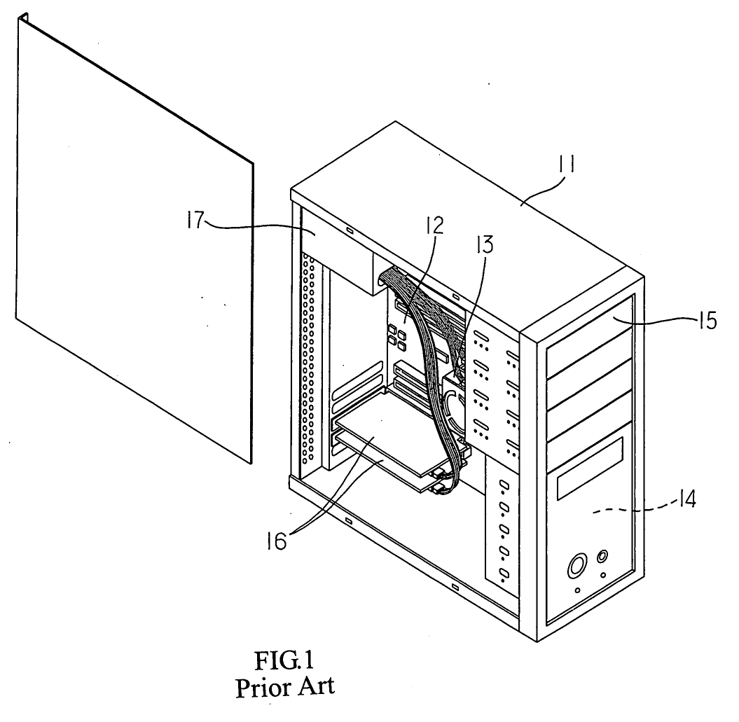

FIG. 2 is a planar view of a prior art computer system apparatus;

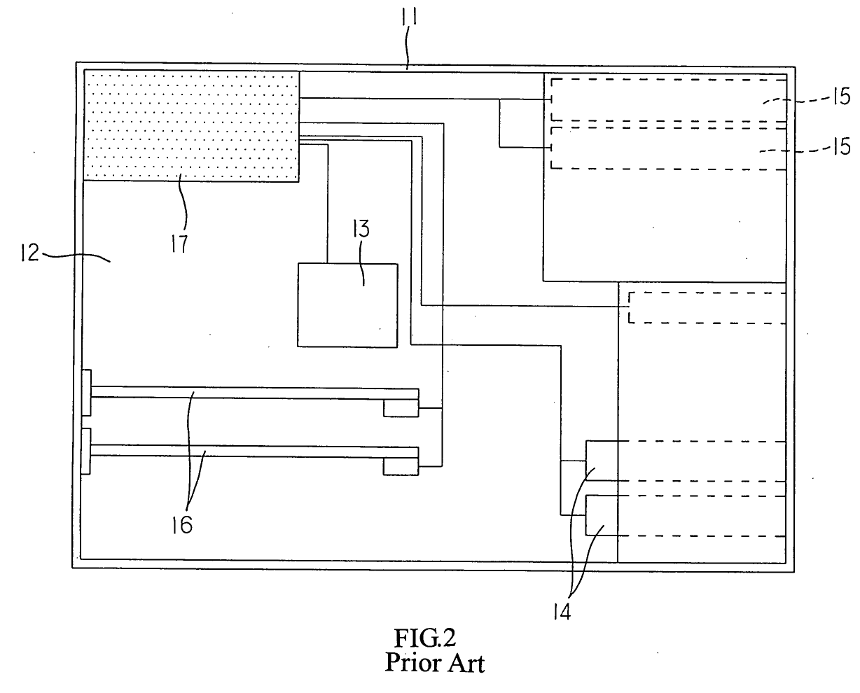

FIG. 3 is a perspective view of a computer system apparatus according to a first preferred embodiment of the present invention;

FIG. 4 is a planar view of a computer system apparatus according to a first preferred embodiment of the present invention;

FIG. 5 is a perspective view of a computer system apparatus according to a second preferred embodiment of the present invention;

FIG. 6 is a schematic view of the layout of a power input port and a power output port of an auxiliary power supply according to the present invention;

FIG. 7 is a perspective view of a computer system apparatus according to a third preferred embodiment of the present invention;

FIG. 8 is a planar view of a computer system apparatus according to a third preferred embodiment of the present invention; and

FIG. 9 is a perspective view of a computer system apparatus according to a fourth preferred embodiment of the present invention;

### DETAILED DESCRIPTION OF THE PREFERRED EMBODIMENTS

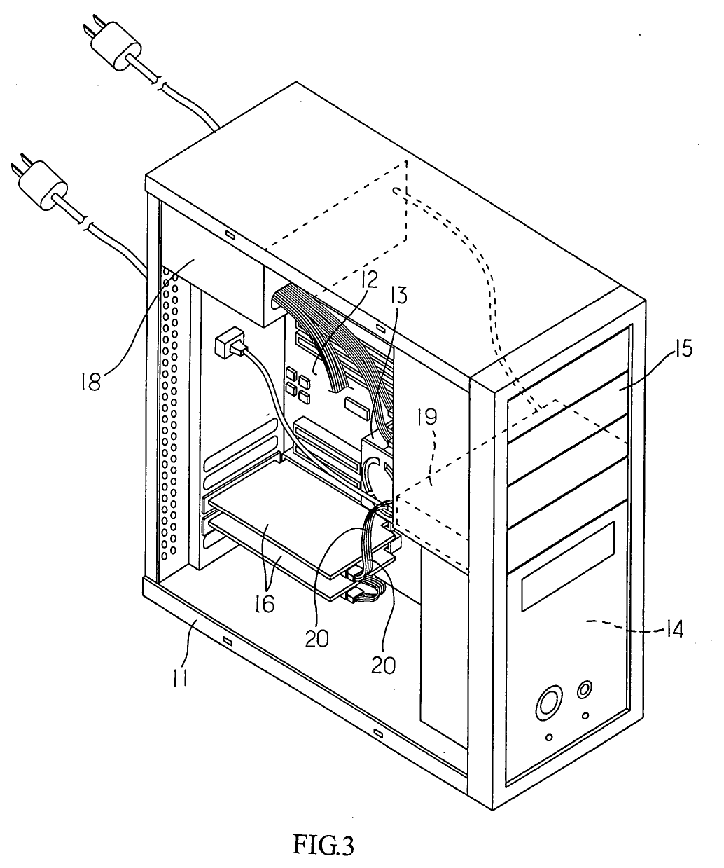

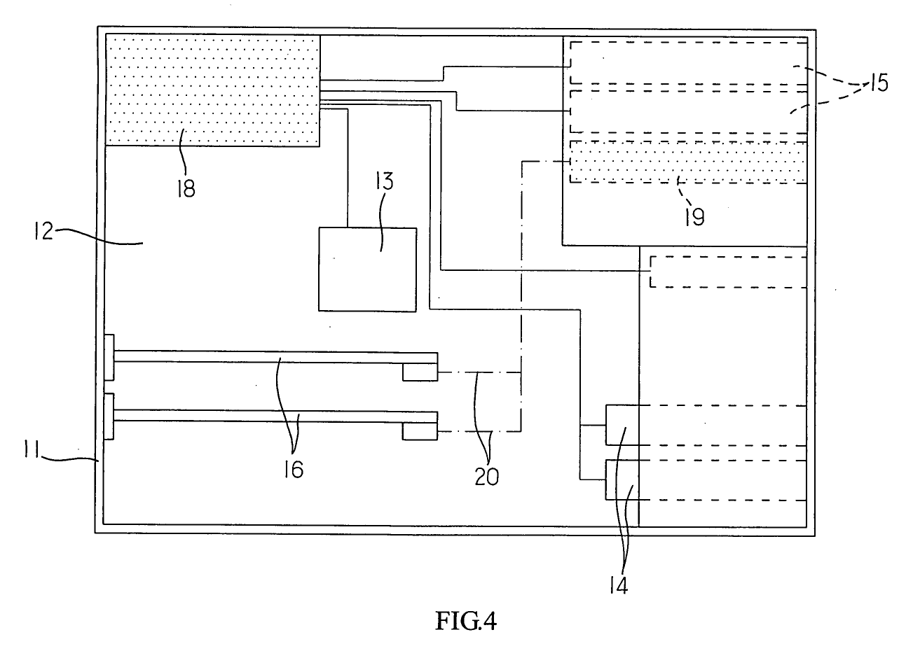

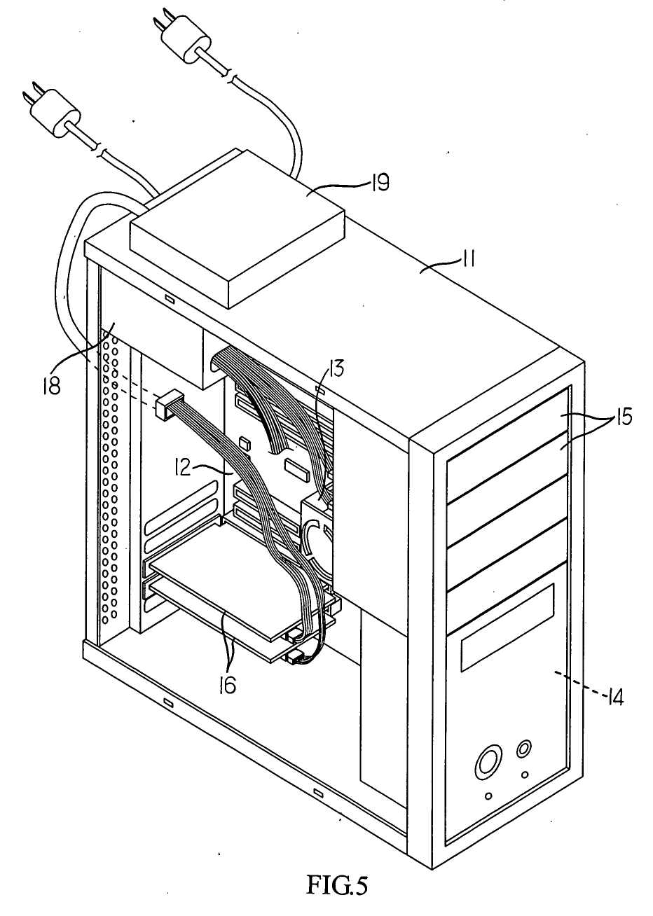

Referring to FIGS. 3 and 4 for the power supply apparatus of a computer system according to the present invention, the computer system includes a casing 11, and the casing 11 installs built-in components such as a motherboard 12, a microprocessor 13, a hard disk drive 14, an optical disk drive 15, a display chip module 16, and a primary power supply 18, and the casing 11 further includes an auxiliary power supply 19 built in the casing 11 as shown in FIGS. 3 and 4, such that the power supply 18 and at least one auxiliary power supply constitute a power supply for supplying the electric power required by the computer system. The auxiliary power supply 19 can be built in the casing 11 or externally connected to the circuit of the computer system as shown in FIG. 5.

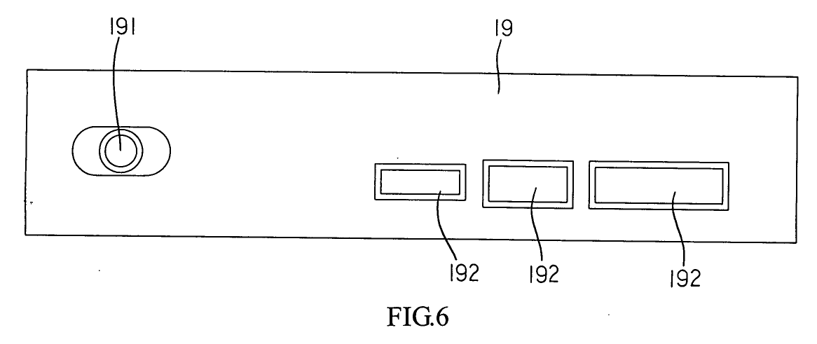

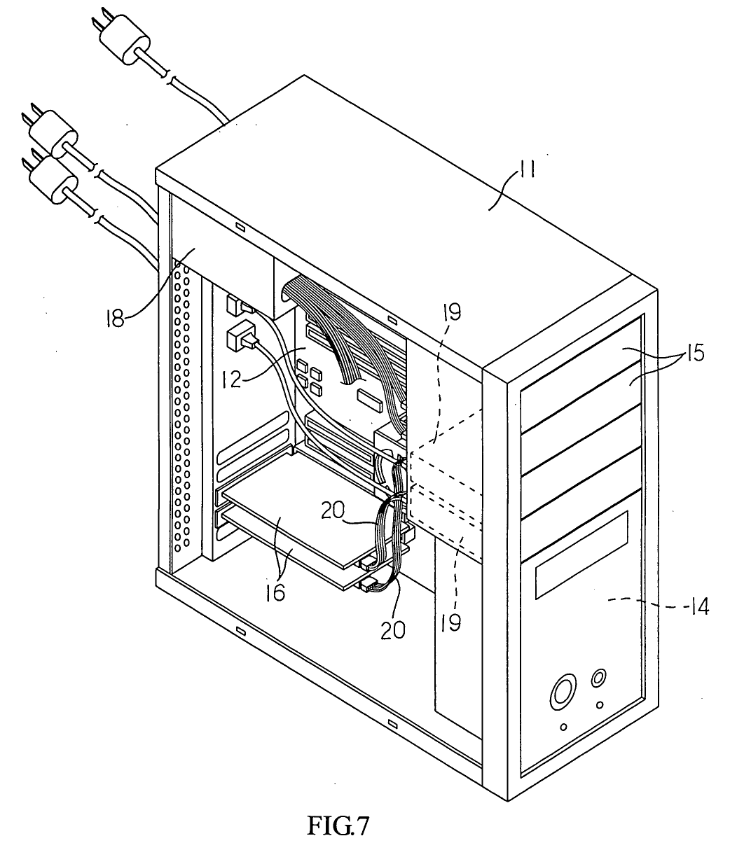

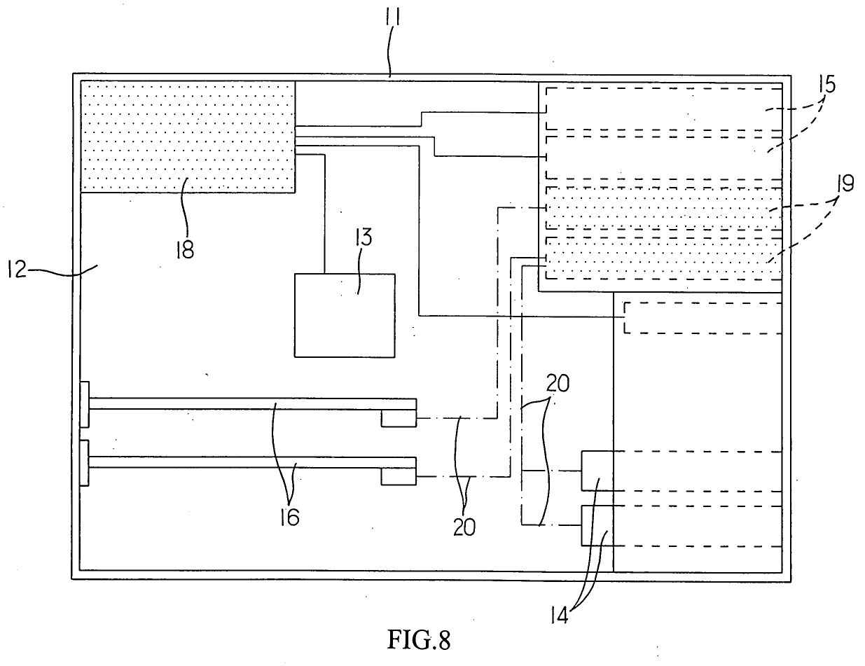

Referring to FIG. 6, each auxiliary power supply 19 includes a power input port 191 and a plurality of power output ports 192 for supplying a DC power for the display chip module 16 of the computer system. For example, the auxiliary power supply 19 supplies a 12V (voltage) DC power and also a DC of −48V and 48V, and the quantity of the auxiliary power supplies 19 can be added according to actual needs as shown in FIGS. 7 and 8, so that the auxiliary power supplies 19 can share supplying the electric power required for the operations of the display chip module 16 of the computer system, such that if the display chip module 16 is upgraded for more complicated operations, the auxiliary power supply 19 can supply a larger operating power to the display chip module 16, so as to assure the stability of operations and improve the operating performance of the apparatus

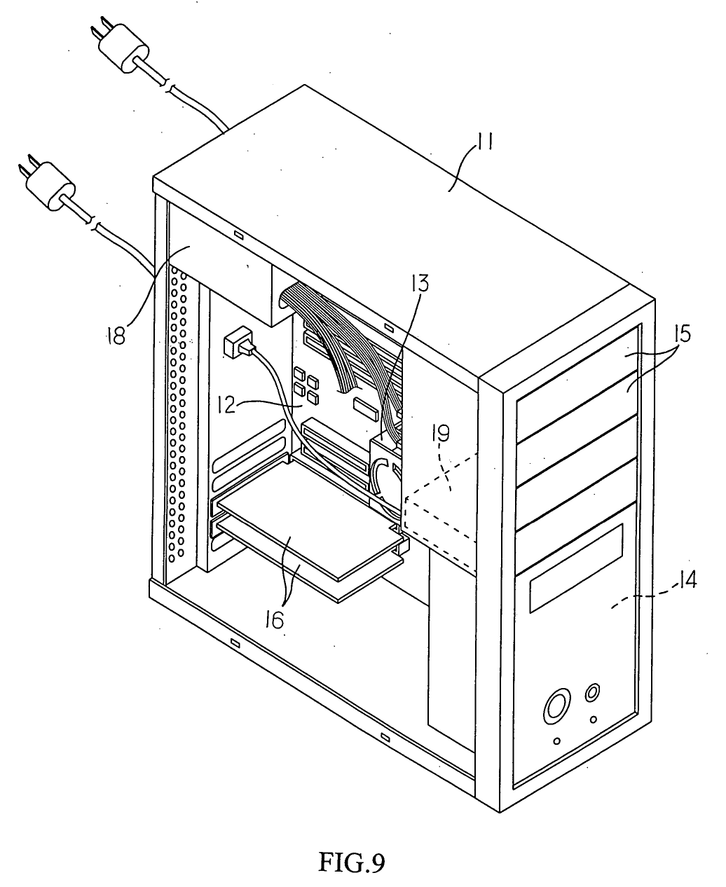

In an embodiment as shown in FIG. 3, the auxiliary power supply 19 is connected to the display chip module 16 through a power cable 20 and the electric current is sent to the display chip module 16 through the power cable 20. Of course, the power supply circuit and the related power detect circuit of the auxiliary power supply 19 can be built directly on the motherboard 12 as shown in FIGS. 5 and 9, such that the motherboard 12 can send the power supply to the display chip module 16 connected to the auxiliary power supply 19 to improve the convenience of installing the auxiliary power supply 19 and avoid too many cables causing a poor cable management inside the casing 11.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power supply apparatus of computer system, installing a primary power supply and at least one auxiliary power supply, and said each auxiliary power supply being built in a casing and electrically coupled to a display chip module of a computer system.

2. A power supply apparatus of computer system, installing a primary power supply and at least one auxiliary power supply, and said each auxiliary power supply being connected externally and electrically to a display chip module of a computer system.

3. The power supply apparatus of computer system of claims 1, comprising a motherboard, a microprocessor, a hard disk drive, and an optical disk drive built in said casing.

4. The power supply apparatus of computer system of claims 2, comprising a motherboard, a microprocessor, a hard disk drive, and an optical disk drive built in said casing.

5. The power supply apparatus of computer system of claims 1, wherein said auxiliary power supply supplies an electric power to said display chip module through said power cable.

6. The power supply apparatus of computer system of claims 2, wherein said auxiliary power supply supplies an electric power to said display chip module through said power cable.

7. The power supply apparatus of computer system of claim 3, wherein said motherboard builds a power supply circuit and a related power supply detect circuit on said motherboard, and said auxiliary power supply supplies an electric power to said display chip module through said motherboard.

8. The power supply apparatus of computer system of claim 4, wherein said motherboard builds a power supply circuit and a related power supply detect circuit on said motherboard, and said auxiliary power supply supplies an electric power to said display chip module through said motherboard.

9. The power supply apparatus of computer system of claims 1, wherein said auxiliary power supply includes a power input port and at least one power output power.

10. The power supply apparatus of computer system of claims 2, wherein said auxiliary power supply includes a power input port and at least one power output power.

11. The power supply apparatus of computer system of claims 1, wherein said auxiliary power supply supplies a 12V direct current.

12. The power supply apparatus of computer system of claims 2, wherein said auxiliary power supply supplies a 12V direct current.

13. The power supply apparatus of computer system of claims 1, wherein said auxiliary power supply supplies a direct current from −48V to 48V.

14. The power supply apparatus of computer system of claims 2, wherein said auxiliary power supply supplies a direct current from −48V to 48V.
